(19) United States
(12) Patent Application Publication
(10) Pub. No.: US 2011/0179116 A1
(43) Pub. Date: Jul. 21, 2011

(54) SYSTEM AND METHOD FOR PROVIDING PERSONALITY-BASED CONTENT AND ADVERTISEMENTS

(76) Inventors: Amiad SOLOMON, New York, NY (US); Jonathan Schler, Petach Tikva (IL)

(21) Appl. No.: 13/007,124

(22) Filed: Jan. 14, 2011

Related U.S. Application Data
(60) Provisional application No. 61/296,352, filed on Jan. 19, 2010.

(51) Int. Cl. G06F 15/16

(52) U.S. Cl. 709/204

(57) ABSTRACT

Embodiments of the invention are directed to a selection and delivery of content. Content produced by a user may be analyzed. A personality related parameter may be generated or determined. A content object may be selected for delivery based on a personality parameter. In some embodiments, a content object may be generated or modified based on a personality parameter.

### CROSS REFERENCE TO RELATED APPLICATIONS

This application claims the benefit of U.S. Provisional Application Ser. No. 61/296,352, filed on Jan. 19, 2010 and entitled “SYSTEM AND METHOD FOR PROVIDING PERSONALITY-BASED CONTENT AND ADVERTISEMENTS”, which is incorporated in its entirety herein by reference.

### BACKGROUND OF THE INVENTION

Various methods and systems for advertising over the Internet exist today. The development of computing devices and/or their ability to communicate has made new advertising methods and systems possible. These systems may employ contextual analysis of various information in order to target users. Yet other systems use cookies or other means in order to track and/or profile users and provide users with advertising material based on activity, fields of interest, web surfing history or patterns etc.

Recent times have seen the advent of social networks such as Myspace™ Facebook™, LinkedIn™ and others. Although advertising techniques known in the art may be used in various environments such social networks, some aspects, such as a personality of a user are not explored, taken into account or used, in particular, by the advertising industry. There is a need for more individualized customization of directing advertising and other content to users.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 shows an exemplary system according to embodiments of the invention;

FIG. 2 shows a schematic block diagram of an exemplary system according to embodiments of the invention;

FIG. 3 is an exemplary flowchart describing a method according to embodiments of the invention; and

FIG. 4 is an exemplary computing device according to embodiments of the invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF EMBODIMENTS OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like.

Unless explicitly stated, the method embodiments described herein are not constrained to a particular order or sequence. Additionally, some of the described method embodiments or elements thereof can occur or be performed at the same point in time.

Embodiments of the invention may be applicable in particular to a variety of systems or platforms, for example, social networks, such as Twitter™, Myspace™, Facebook™ LinkedIn™, or other social networks, search platforms, systems or engines, or even some email systems, such as hotmail, which incorporate some social networking features. Any system, device, application or platform that may be used by a number of users in order to communicate with each other (as a whole or in subsets), either offline or in realtime, may be applicable and may benefit from, use or implement embodiments of the invention. For the sake of simplicity, applicable systems, networks, devices or platforms will be referred to herein as “social networks”. Although some embodiments may be related to online users, e.g., users connected to the internet and possibly associated with social networks, in other embodiments, advertising or other material may be selected based on a personality of a user or a potential customer and may be communicated to devices other than a personal or other computer. For example, advertising or other material selected as described herein may be provided to a mobile device such as a smartphone or other applicable devices over a wireless network. Any communication network or platform may be used with any presentation device in order to communicate and present content selected as described herein, accordingly, embodiments of the invention are not limited by the methods or systems used for communicating, displaying and/or providing selected content.

As discussed below, particularly useful features for purposes of the present invention may be the posting of “status” feature included in a large number of social network sites, which permits users to broadcast or multicast substantially realtime information about their immediate past, present or intended future activities to subscribers, followers, friends, etc. Other useful features for purposes of the present invention may be electronic mail (email), text exchanged by chat applications, on-line and/or web based journals, blogs or forums, web search engines etc. It will however be recognized that any content authored or produced by a human and received as input may be analyzed in order to evaluate, determine, classify or identify the personality of such human or determine parameters related to the personality of such human. For example, audio content may be analyzed (e.g., using word spotting, emotion sensing or other techniques known in the art) and/or converted to text and such text may be analyzed as described herein. Embodiments of the invention may be particularly applicable to text, accordingly, text and text analysis will mostly be referred to herein.

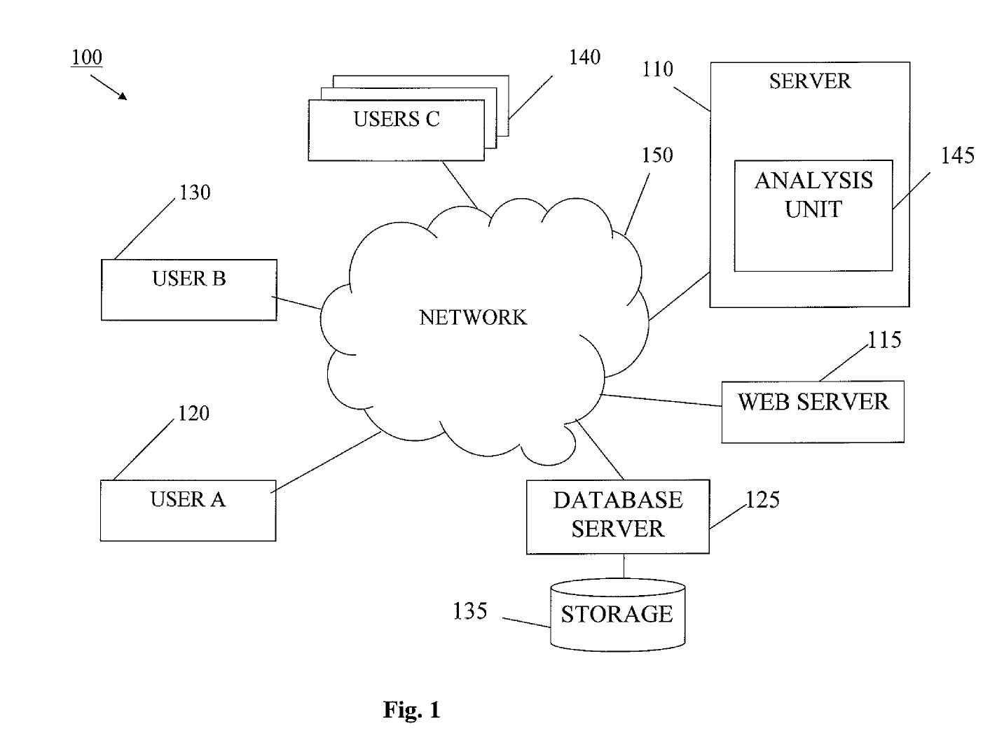

Reference is made to FIG. 1, showing a schematic view of an exemplary system 100 according to embodiments of the invention. System 100 may include a server 110, an analysis unit 145, a web server 115, a database server 125, a storage 135 operatively connected to database server 125, a user A 120, a user B 130, a plurality of users C 140 and a network 150 for communication therebetween. For the sake of simplicity, computing devices operated by users A, B and C are not particularly shown, however, it will be recognized that users A, B and C as referred to herein denote a human user operating any applicable computing device. For example, users A, B and C may operate a personal computer, a desktop computer, a mobile computer or phone, a smartphone, a laptop computer, a notebook computer, a terminal, a workstation, a server computer, a personal digital assistant (PDA) device, a tablet computer, a network device, or any other suitable computing device enabling users A, B and C to communicate with each other and/or with one or more of servers 110, 115 and 125. Servers 110, 115 and 125 may be any applicable server platforms, e.g., one or more server computers or any one or more of the devices described herein with reference to devices that may be operated by user A. Servers 110, 115 and 125 and computing devices operated by users A, B and C may include hardware, software, firmware modules, or a combination thereof. It will be recognized that embodiments of the invention are not limited by the type or nature of Servers 110, 115 and 125 and/or devices operated by users A, B and C.

Web server 115 may provide web pages to users A, B and C. Users A, B and C may interact with server 115 and/or with each other by interacting with web pages provided by server 115. Accordingly, an application (not shown) on server 115 may collect various information, parameters, information or data originating from or destined to users A, B and C. For example, a software module may be associated with a web server application and may receive or otherwise obtain any relevant information exchanged with or by users or communicated to/from users A, B and C. For example, a social network may be supported, operated or otherwise related to web server 115. In such case, users A, B and C may logon to web server 115 and may exchange content via server 115, e.g., by posting text. In such case, as information exchanged by users flows through sever 115, such information may be captured, e.g., by an application operatively connected to a web server application. For example, posts, emails and the like may all be captured and analyzed.

Network 150 may be, may comprise or may be part of a private internet protocol (IP) network, the internet, an integrated services digital network (ISDN), frame relay connections, modem connected to a phone line a public switched telephone network (PSTN), a public or private data network, a local area network (LAN), a metropolitan area network (MAN), a wide area network (WAN), a wireline or wireless network, a local, regional, or global communication network, an enterprise intranet, any combination of the preceding and/or any other suitable communication means. It will be recognized that embodiments of the invention are not limited by the nature of network 150 insofar as network 150 enables a communication between devices as described herein.

According to embodiments of the invention, users, e.g., users A, B and C may exchange or communicate data or information. For example, users A, B and C may be part of a social network, e.g., Twitter™, Myspace™, Facebook™, LinkedIn™ or the like. A social network may be supported or implemented on web server 115. Accordingly, users A, B and C may login to web server 115 in order to participate in the social network, a forum or other applications or environments. In such scenario, a data collection module or application as described herein may obtain any relevant information, data or parameters communicated or exchanged by users A, B and C via web server 115. Such data collection module may provide analysis unit 145 with any applicable data, parameters or information. Analysis unit 145 may analyze data, parameters or information as described herein and may, based on such analysis, determine, derive, compute or generate at least one parameter, indicator or criteria related to a personality of a user, e.g., one of users A, B and/or C. A parameter related to a personality may be used in a process of selecting content to be delivered to a user. For example, an advertisements delivered to a user may be selected or generated based on a user's personality or based on at least one parameter related to or indicative of, a user's personality. Delivery of content, e.g., advertising material, may be performed by an advertisement server (Ad server). In some embodiments, a reference, pointer or any other selection parameter may be provided to an Ad server, possibly along with one or more references to the relevant user, e.g., an address or connection parameter that may enable the Ad server to directly interact with the user's computing device. The Ad server may use such provided references to select an advertisement and deliver the selected advertisement to a user. It will be understood that embodiments of the invention may utilize or interact with an ad server as known in the art. For example, following a selection of content for delivery based on a personality of a person, embodiments of the invention may interact with an ad server in order to execute the actual delivery of selected content.

According to embodiments of the invention, analysis unit 145 may analyze or otherwise process information, parameters or data produced by users A, B and C and collected as described herein. Based on analysis such as text analysis, analysis unit 145 or another module or unit may compute, calculate, identify, determine or derive one or more parameters related to a personality of users A, B or C. Based on one or more parameters, indicators, criteria or other information related to a personality of a user, analysis unit 145 or another module or application, e.g., an Ad server (not shown) or an application thereon may select content and serve the selected content to one or more users, e.g., users A, B and/or C.

Alternatively or additionally, a number of modules or applications may be used. For example, a data collection module, component or application may collect data. For example, a software data collection module residing on web server 115 may obtain any text or other information exchanged between users who are part of a social network. For example, text and metadata related to posts, status updates, chat messages and/or emails handled by a web application on web server 115 may be provided to such software data collection module and/or otherwise obtained by such data collection module as known in the art, e.g., using specific application program interface (API's), kernel level modules, hooks or plugins.

A second module, e.g., analysis unit 145, may process collected and other data as described herein and a third module, e.g., an advertisement server (Ad server) or application thereon, may select content based on results of the analysis, a profile of a user, or based on parameters related to the analysis and may further deliver a selected content to a user. Alternatively or additionally, data may be collected and/or processed on devices operated by users A, B and C. For example, a software module (not shown) installed on a device operated by user A may collect any relevant data or parameters and may further communicate such collected data to analysis unit 145.

In some embodiments, a content or advertisement server (Ad server) may select a specific content object or advertisement from a plurality of content objects based on parameters provided by embodiments of the invention. For example, analysis unit 145 may analyze posts, status updates or other communications or events related to a social network. Such analysis may determine, or be used to determine or identify various personality traits, aspects and/or parameters related to users. Such personality traits or parameters, or other computed parameters, may be used to select a type of content or advertisement to be delivered to a specific user or a predefined set of users. In some embodiments, analysis unit 145 or other module or unit may provide an advertisement server with a pointer, reference or type selection and leave the selection of the specific advertisement or content to the advertisement server. Such configuration may enable providing a variety of advertisements based on a single selection made by embodiments of the invention.

Data, text or other information collected as described herein, may be analyzed, either alone, or in light of, or in combination with, other information, parameters or data. According to embodiments of the invention, based on text analysis or other processing of actions, communications, social relations and/or other social aspect, advertising content may be served, possibly in realtime. Any applicable analysis may be employed by embodiments of the invention. For example, word spotting or word combinations analysis may be performed. Other relevant analyses may be analysis of multimedia content or behavioral or contextual analyses as known in the art. It will be understood that in some embodiments of the invention, any type of data or information that may reflect on a personality of the producer or author of the information may be collected and analyzed. For example, text analysis may be combined with other information, such as analysis of data from various sources or related to various aspects or contexts, e.g., behavioral related information, e.g., the rate with which a user types, annotations used by a user, icons added to text or communications, demographic information, etc. Any analysis or processing may be used, for example, to refine or disambiguate content or advertisement selection.

In some embodiments of the invention, some background information about the user may be known based on the user's biographical information (e.g., age, gender, residence, etc.), or interests or associations (e.g., by group memberships, etc.) Such information may be used together with realtime information, e.g., posts or status updates, electronic mail (email), text exchanged by chat applications, on-line and/or web based journals, blogs, forums or search strings. Any such information may be used to determine, compute or otherwise derive at one or more parameters related to a personality of a user. For example, it may be known that a specific term, when used by students, possibly in a specific region or state, has a specific meaning, accordingly, taking into account the fact that an author of analyzed text is a student in such state will cause analysis unit 145 to treat such term adequately, e.g., correctly interpret the term.

Any data or aspects of data may be processed or analyzed. For example, analysis of posts, status updates or other text generated by users may include identifying a linguistic or language style. A language style may include any related aspects, e.g., terms used, structure of sentences, length of sentences or any other identifiable patterns, structures or other linguistic elements. A language style may be used in various ways. A user's profile (maintained as described herein) may include, in addition to parameters, data and information described herein, an indication of a language style of the user. Users may be identified, associated, selected, viewed or otherwise treated based on a language style. For example, it may be the case where a specific language style is shared by users who share other aspects or parameters. For example, users from a specific geographical region may share the same language style, students in a specific university may share another language style. Accordingly, text analysis or other techniques aimed at determining one or more personality traits of a user may take the relevant language style into account and may be performed based, at least in part, on a language style.

Any data, parameters or other information from various sources may be combined, processed and analyzed. For example, analysis of text generated by a user may be based on the user's demographic data. For example, text related to the user may be analyzed based on a user's address or nationality, possibly taking into account aspects such as a language style of the country or region. Other aspects, e.g., games the user plays, friends, type of activities or any other obtainable information related to the user may some or all be combined by embodiments of the invention in profiling a user. Such profiling may be reflected in a profile maintained for specific users. In particular, a profile may include one or more parameters related to the user's personality. For example, scores related to one or more personality traits may be stored in a user's profile. For example, parameters in a user's profile, reflecting factors such as openness, conscientiousness, extraversion, agreeableness and neuroticism factors according to the big five personality traits or “Big Five” factors of personality as known in the art may be maintained, modified and/or updated according to analysis of text or other data obtained from a user. As known in the art, the “Big Five” factors, also referred to as the “Five Factor Model” or FFM of personality, are believed to accurately define a human personality at the highest level. The five factors are trusted to define major personality traits and to represent the basic structure behind all personality traits. Accordingly, a personality of a user may be reflected or represented by parameters or values related to factors such as the “Big Five” factors. In some embodiments, personality related parameters, possibly included in a user's profile that may be stored by database server 125 on storage 135, may be updated or modified based on text analysis of text produced by an author, e.g., a member of a social network producing or authoring data as described herein. As discussed herein, personality related parameters, possibly stored in a user's profile, may be updated or modified based on any analysis or processing of any applicable data, parameters or information that may be obtained as described herein.

According to embodiments of the invention, a personality or a personality parameter may be numerically expressed. For example, the five (5) “Big Five” factors discussed herein may be used. For example, a user's profile may include five scores, grades, levels, numeric values or other parameters respectively related to the “Big Five” factors. For example, using a simplified scale of one to ten (1-->10), a first user may be represented by a score of 7 for openness, 5 for conscientiousness, 3 for extraversion, 9 for agreeableness and 2 for neuroticism while a second user may be represented by a score of 1 for openness, 9 for conscientiousness, 2 for extraversion, 1 for agreeableness and 9 for neuroticism. Although a highly simplified profiling example is discussed herein, it will be recognized that any method, algorithm or means as known in the art for generating and/or representing a personality or a parameter related to a personality may be employed by embodiments of the invention, and a user's or group's profile as described herein may include any data or parameters that may be generated by such methods or means.

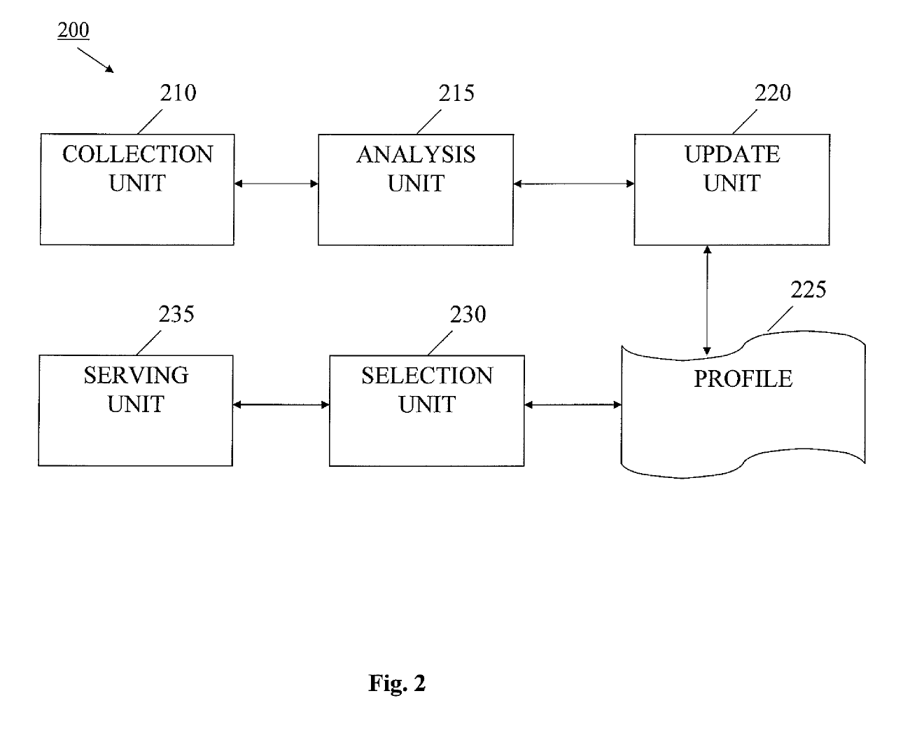

Reference is made to FIG. 2, which shows a logical view of exemplary components in an exemplary system 200 according to embodiments of the invention. As shown, system 200 may comprise a collection unit 210, an analysis unit 215, an update unit 220, a profile 225, a selection unit 230 and a serving unit 235. According to embodiments of the invention, collection unit 210 may be any suitable unit or module configured to collect text or other data produced by users. For example, collection unit 210 may be a module operatively connected to web server 115. Such collection module may be provided with messages or other data that may be communicated by users to web server 115. For example, social networks as described herein may be supported or implemented by web servers such as web server 115. Accordingly, text or other data exchanged by users may be provided to or may be communicated via web server 115. Such data may be delivered to collection unit 210 or it may be intercepted by collection unit 210, e.g., at a network level or application level. In some embodiments, collection unit 210 may be a kernel or other level program that may interface or interact with other applications or programs, e.g., a web server application and may thus obtain any applicable information, data or text. Analysis unit 215 may be similar to analysis unit 145 described herein with reference to FIG. 1. Analysis unit 215 may analyze data provided by collection unit 210. Analysis unit 215 may be provided with additional or other data, parameters and information as described herein, e.g., demographic information related to members of a social network etc. One of the outputs of analysis unit 215 may be an evaluation of a personality of the user associated with the data provided by collection unit 210. Results, scores or other parameters or data produced by analysis unit 215 may be provided to update unit 220. Update unit 220 may update a user's or group's profile, e.g., profile 225. Update unit 220 may update, modify or otherwise manipulate a profile according to various algorithms, criteria, thresholds, rules or any other parameters. Profile 225 may be a file or other information object and may be stored, for example, on storage 135 connected to database server 125 as shown in FIG. 1.

Selection unit 230 may select a content for delivery based on information in profile 225. For example, advertisements may be associated with metadata that may associate them with specific personality parameters. For example, metadata associated with an advertisement or content may reflect the content's or advertisement's suitability to one or more personalities, personality traits or aspects. Accordingly, provided with parameters extracted from profile 225, selection unit 230 may search a content repository (not shown) for suitable content based on a match of personality parameters indicated in the content's metadata and in the relevant profile. Serving unit may receive a content selection and information related to a destination of the content and may server, provide or deliver the selected content to its destination. For example, serving unit may be an Ad server or an application thereon, and may receive from selection unit 230 a reference, e.g., pointer, unique resource location (URL), file name or other reference to a content object along with a destination, e.g., an internet protocol (IP) address and may deliver the referenced content to the specified destination or address.

According to embodiments of the invention, using a personality or a personality related parameters for a selection and delivery of content may be applicable to any environment, circumstances or context. For example, upon identifying or determining a personality of a user, advertisement suitable for the user's personality may be delivered to the user while visiting any web site, e.g., web sites not necessarily related to a social network, or advertising material suitable for the personality of the user may be delivered to his or her smartphone or any suitable device, operating in any applicable environment. As known in the art, Ad servers may be used to consolidate advertisement delivery. As described herein, embodiments of the invention may interact with Ad servers or other entities in order to cause advertisements to be selected and delivered according to a personality of the receiving end. For example, selection unit 230 described herein may operate in conjunction with any content delivery platform and may select content for delivery based on a received personality parameter and using metadata associated with content as described herein. Accordingly, selection and delivery of content based on a personality parameter may be applicable to any environment, context or circumstances. As described herein, advertisements may be selected, based on a personality, such that they comprise the format, language, colors, attributes or other aspects that may be the most appealing to the user with the specific personality type. Accordingly, embodiments of the invention may increase the probability that a receiver of an advertisement will be affected as intended by an advertiser.

A text or other analysis, e.g., performed by analysis unit 215, may be configured to produce a score or set of scores based on analyzing an input text. An input text may be an entire or part of a message, e.g., posts or status updates, electronic mail (email), chat message or posts to a journals or blogs written by the specific user. For example, analysis unit 145 may be provided with a post from a user that may be intercepted or otherwise obtain by a collection module on web server 115. Analysis unit 145 may analyze the post and further score the text in it with respect to a predefined set of evaluation parameters or factors, e.g., the five “Big Five” factors discussed herein. An update module may be provided with the scores produced by analysis unit 145 and may update the relevant user's profile. An update of a profile may involve various logic and/or algorithm. For example, an update may comprise calculating various averages such that an update of a profile reflects trends, smoothes errors or peaks, or is otherwise configured to best reflect input from analysis unit 145 in a user's or group's profile.

Information communicated over social networks may be different from information communicated over other platforms. For example, in contrast to the way people might express themselves or provide information when interacting with an authority or when filling out surveys, people may express themselves more freely over social networks. For example, a typical social network platform such as Facebook™, Twitter™ may enable users to provide each other with text or other messages they author themselves, typically in free format, and in a way that may expose their personality. For example, posts or status updates, electronic mail (email), text exchanged over chat applications, or blogs, may all be authored and communicated in ways similar to a normal, day-to-day conversation. By tracking and/or analyzing such communications, embodiments of the invention may identify and/or determine users' personalities or traits.

According to embodiments of the invention, analysis of input from a user may comprise analyzing patterns, structures or other linguistic constructs or elements that may be related to semantics, grammar, syntax, or any other parameters that may reflect on the personality of the author or producer of the input. In some embodiments, a personality or a personality trait, factor or parameter may be determined by identifying specific attributes in input from a user. For example, markers may be used. For example, markers of a neurotic personality may be a frequent use of first person pronoun, frequent use of words such as “myself” and “me” with high proportion in sentences and text, short sentences, frequent use of negative terms such as “not” or “none” and high rate of negative emotion phrases.

Accordingly, the following text may cause embodiments of the invention to associate the author with a high neurotic score: “I need to do well in college. Graduate early reach high! I need to make new friends, but I am not doing very well at either of my goal. I feel lonely sometimes and no one to go to. But when I do hang out with my friends, I still feel lonely. Because I am just being with to try to make friends here and fit in. But I am not enjoying myself at all. I did make some new friends here that I could actually have fun with. But I do not feel like hanging with them. Many times, I just wanted to be by myself in my room. I am also looking for jobs. But nothing seems to be working lately. I am starting to sit back and sleep a lot more than I used to. I studied less; therefore, my grades are not as good. I wanted to make all A's but now, sigh. But I am not giving up because I believe in myself. I know I can do it, I am just not trying enough. Hopefully soon my motivation will be high again and things will start to work out again. I know it will, I can do it! Being here in college other than the need of meeting new people and getting good grades, I also need a lot more money. Money is an issue here. I have promised my parents that I can afford myself to college. And now, I am spending more than I have expected. And I do not want to go ask my parents for money. Because I want to keep them from being as little stressed out as possible”.

For comparison, the following text may cause embodiments of the invention to associate the author with a low neurotic score: “college has definitely been an exciting time for me. i have been able to have so much more liberty than i used to back home. college is so much more intense but has so many more advantages than disadvantages. meeting people has been wonderful. i have discovered that i am more prejudiced than i thought i was against asians. for some reason i just do not really like them. i have also learned that in college keeping your friends is not as important as making sure you have good grades. i had to tell a girl in my nursing project group that she was no longer a part of the group because she skipped a meeting. i really did not care that she got mad at me. i did not do it out of spite. i did it to teach us all a lesson. the last thing i am here to do is crush somebody for my successes. i am here to contribute and to learn. another thing that i think college has been about for me is the opportunity to explore many facets of life. i have tutored and helped a major research study. i am in the men's chorus. men's chorus indeed, college has been a very positive experience. i feel that professors do care about how students do. students are the ones who do not care and then blame it on the professors. i will get an a in my courses despite my professors. i think another thing i have learned is that human nature is human nature even if i have left people i did not like back home. i come here and these are people with the qualities i did not like. i know i will learn many more things in my college career.”

Analysis of information exchanged by users may enable categorizing users' personalities. For example, based on analyzing posts or status updates, user fields of interests, activities, plans or other behavioral aspects, personality traits, parameters or factors may be identified, deduced or determined. Such personality factors may be used to categorize users based on common personality traits, factors or aspects. Such categorization may enable delivering a specific advertisement or content to a group of users that may share a common personality trait or factor. According to embodiments of the invention, a number of aspects may be combined. For example, selecting users who share common fields of interests, activities, or are part of a common social network and further share similar personality traits to receive a specific, possibly same or identical content such as an advertisement, may prove highly effective, and accordingly, highly desirable. Accordingly, an advertisement may be selected based on aspects or parameters, e.g., common personality traits, related to a group. For example, assuming users C 140 are identified as a group, e.g., sharing a common meta-personality, embodiments of the invention may deliver the same advertisement to users C 140.

According to embodiments, a repository or database, e.g., database server 125 and/or storage 135 may store any relevant information, e.g., in a user profile. A module or component collecting and/or analyzing data as described herein and/or selecting content or advertisements for delivery as described herein may receive or otherwise obtain any required data from such repository. For example, database server 125 and/or storage 135 may be operatively connected to server 110 and/or analysis unit 145. Accordingly, analysis unit 145 or other module may query such repository for any applicable information, parameters or data. For example, such database may store user profiles or other data reflecting, among other parameters, a user's personality as described herein.

Any personality aspects may be reflected in a user profile that may be updated, possibly in real time. For example, profiles stored on a database as described herein may be updated, for example by update unit 220. Updating a profile may be done so that any relevant changes in applicable parameters or aspects related to a personality are reflected in the updated profile. For example, if a user begins to exhibit a new personality trait the relevant profile may be updated in order to reflect such change. Likewise, a meta-personality may be associated with a group of users and may be maintained in a relevant profile reflecting a personality or a set of personality traits or parameters that are common to members of the group. A group may be dynamically or otherwise defined according to any applicable criteria. For example, a group may be defined such that all users included in such group are associated with one or more personality relate scores or levels as described herein. For example, a group may be users who score more than a predefined score with relation to one or more personality traits or factors, e.g., one or more of the “Big Five” factors.

In some embodiments of the invention, a profile may be dynamic or it may be static. A dynamic profile may be updated according to a predefined frequency, every time a relevant event is detected or according to any policy. For example, a profile may be updated every time text from the user is processed. In other cases, possibly while data from the user is continuously processed and parameters are saved, the profile may be updated once a day. A number of profiles may be maintained for a user, group or network. For example, a first realtime, up to date profile may reflect the user in realtime while another profile may reflect historical aspects, e.g., by being updated once a day and/or averaged in order to reflect trends or other aspects related to the relevant network, group or user. Dynamic profiles may be maintained by giving greater weight to more recent updates or otherwise averaging data.

A dynamic profile may be a temporal profile. A temporal profile may reflect realtime parameters or information related to the user, group or network. For example, temporal profile may reflect or indicate a user's current psychological or personality parameter or aspect. For example, a mood, state of mind or other psychological aspects that may be transient may be reflected in a temporal profile. Accordingly, content or advertisements may be selected and delivered to a user based on the user's current mood, or emotional state. Other than analyzed text or other information authored by a user, other information that may be related to a user's state of mind, mood or other mental aspects may be used for updating or maintaining a temporal profile, for example, events such as birthdays, funerals, dating or others, e.g., as may be determined from status updates may be reflected in a temporal profile.

A profile may be generated, updated or maintained according to any point of interest. For example, a publisher, advertiser or other interested body may require profiles to reflect specific aspects. For example, an advertiser interested in selling extravagant or flashy cars may be interested in providing related advertisements to potential customers associated with a suitable personality, e.g., users associated with a high score with relation to extraversion. Accordingly, any applicable personality traits, parameters or aspects may be defined, possibly based on a definition from an advertiser, operator, publisher or other interested body. Following reception of a suitable personality for a specific advertisement, selection unit 230 may select the specific advertisement to be delivered to users having the suitable personality. For example, if a specific product is suitable for a specific personality, than embodiments of the invention may only deliver an advertisement for such product to users with a suitable personality.

Embodiments of the invention may enable an operator, publisher or other entities providing content and/or advertising material to manage advertising campaigns or other advertising content delivery. In some implementations, personality characteristics or aspects of users may be identified and/or recorded, communities or groups may be identified and may further be used in order to deliver advertising or other content to users. Profiling of users, groups or communities may be performed based on analyzing user interactions and communications as described herein. Interactions analyzed may be between users or they may be between users and applications. For example, posts or status updates may be analyzed as well as interactions with gaming or other applications that may be embedded in a social network platform, e.g., online games. For example, the speed with which a user plays, e.g., uses the mouse and/or keyboard, the characters or avatars typically selected or the type of games selected may all be analyzed. For example, a user that typically selects war games, or competitive games may be classified or profiled (with respect to his personality) differently from a user who tends to select games involving other aspects, e.g., chess. While an operator of a social network platform may be restricted from exporting user information collected or obtained as described herein, such operator may use such information in order to launch advertising or other campaigns.

Selecting a content object to be delivered to a user may be based on at least one parameter that may be calculated, computed or otherwise derived based on the personality of the user. Selection of the content for delivery may be based on the parameter and on a characteristic of the content for delivery. For example, based on a parameter indicative of a user's personality, a content may be selected based on characteristics such as a color, a background, a visual effect, and an audio effect associated with the content. In other embodiments of cases, selecting a content object to be delivered may be based on text or content in a message received or generated by the user, or otherwise associated with a user for which content is selected.

As described herein, in some embodiments, a plurality of content objects, e.g., advertisements, may be generated according to a respective plurality of personalities or personality related parameters. For example, a first advertisement for a car may be generated to suit an extravagant person and a second advertisement, for the very same car, may be generated to suit an agreeable person. Accordingly, a plurality of advertisements for a given, same or even identical product or service may be generated such that each one of such plurality of advertisements is suited for a specific personality. Such plurality of advertisements may be generated in advance and stored, e.g., on storage 135. Such plurality of advertisements may further be associated with metadata that may indicate their respective suitability to a plurality of personalities. For example, characteristics of a first advertisement for a product or service may comprise flashy background colors, bright fonts, and specific audio effects suitable for (or matching a personality parameter of) a first personality and a second advertisement, for the same product or service, may comprise mellow background colors, smooth fonts, and mellow audio effects suitable for a second personality. Such first and second advertisements may be stored in association with metadata indicating that the first advertisement is suitable for an extravagant personality and the second advertisement is suitable for an agreeable personality. Accordingly, when selecting an advertisement for delivery, selection unit 230 may examine metadata associated with advertisements, identify a match between the metadata and the personality of the target or destination and, if a match is determined, select the advertisement for delivery.

In other embodiments, a content or advertisement may be generated in realtime or on-the-fly, based on a personality of a user, or a user's profile. For example, a basic or base content object or advertisement may be used and modified according to parameters in a profile. For example, background colors, accompanying music, tune or other audio effects, special effects, e.g., various visual effects may all be added to, or modified in a basic or base advertisement. Such generation, modification or alterations may be based on a personality or profile related to the destination of delivery and may be performed substantially immediately prior to delivering the advertisement to a specific user, group or network. Such realtime modifications or alterations of a content may be according to parameters related to a personality. For example, scientific citations may be included in an advertisement to be delivered to a more conscious person and may be omitted from the advertisement when delivered to a more extravagant person. Any logic may be applied when producing content that is to be best suited for a specific personality. Generation of content or advertisements as described herein may be applicable to online and/or offline generation of content. Accordingly, methods or logic for generating content ad described herein may be used upon selecting a content for delivery, e.g., online or they may be employed in a process of generating content in offline mode, e.g., generating a plurality of versions of a specific advertisement where each version is generated based on a specific set of personality parameters as described herein.

Selection of content for delivery may be based on more than one personality trait or parameter. For example, advertisements may be generated to suit or be more effective for conscientious and open personalities, for extravert and neurotic personalities etc. According to embodiments of the invention, any combination of personality parameters as described herein may be used as input to a content generation, selection or delivery process or logic.

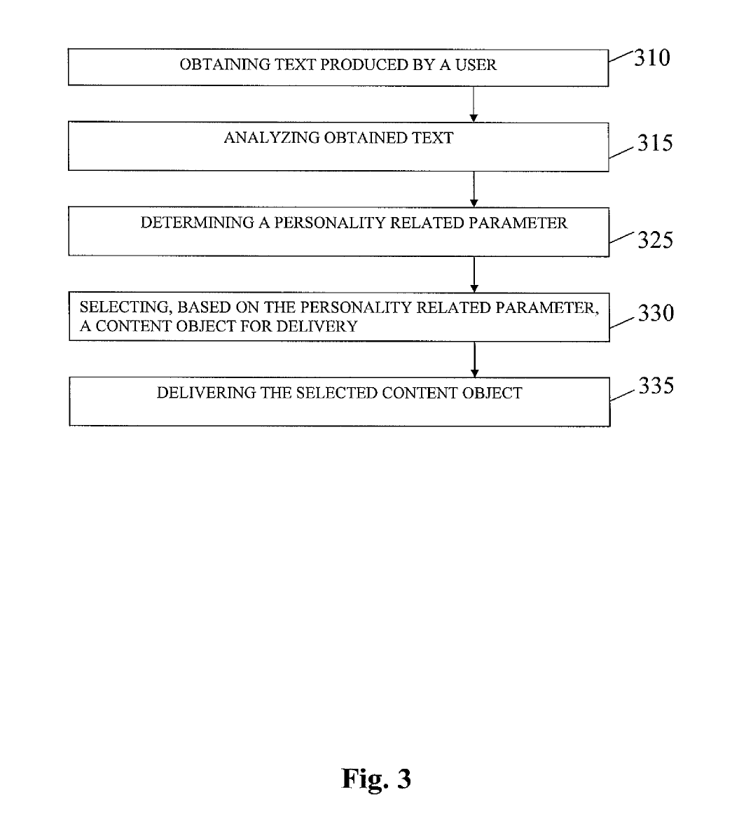

Reference is made to FIG. 3 that shows an exemplary flowchart describing a method according to embodiments of the invention. As shown by block 310, the method may include obtaining text produced by a user. For example, text may be obtained, received or extracted from posts, status updates, chat messages and/or emails by a collection unit or module as described herein. As shown by block 315, the method may include analyzing obtained text. For example, analysis unit 215 may perform text analysis of in relation to obtained text. As shown by block 325, the method may include determining a personality related parameter. For example, one or more parameters related to a personality of the author or producer of the text, e.g., a personality trait may be identified, computed, calculated or otherwise determined based on text analysis as described herein. As shown by block 330, the method may include selecting, based on a personality related parameter, a content object for delivery. For example and as described herein, an advertisement may be selected or generated based on a match between metadata associated with the advertisement and a personality parameter determined as described herein. As shown by block 335, the method may include delivering the selected content object. For example, serving unit 235 may deliver a content object selected by selection unit 230.

It will be recognized that delivery of content selected as described herein may be over any network, by any server or other delivery system and to any device. For example, a personality parameter of a user may be used in order to select content by a first computing device. Such selected content may be distributed by a number of other computing devices, e.g., an advertisement server or a set of servers operated by a publisher. Content selected or generated as described herein may be provided over any suitable network or medium. For example, content may be delivered over a wireless network such that personality based content is delivered to wireless mobile devices, e.g., smartphones, or content may be delivered over the internet, e.g., to home computers, as part of content delivered to a web browser. Content generated and/or selected for delivery based on a personality may be delivered to any suitable device, e.g., a home computer, a smartphone or any device capable of presenting content. Accordingly, it will be recognized that determining a personality or a personality related parameter of a user may enable embodiments of the invention to select and deliver content using any methods as known in the art and to any suitable device as known in the art. Embodiments of the invention may be integrated with various systems or platforms. For example, some or all of the units described herein, e.g., with respect to FIG. 2 may be incorporated into a publisher's system, an advertising system or any other system such that functionalities and/or methods described herein, e.g., identifying, characterizing or profiling a user's personality, generating and selecting content suited for a specific personality may be integrated with other systems or functionalities. Accordingly, numerous existing delivery and/or advertising systems or platforms may benefit from embodiments of the invention. For example, it would be obvious to a person having ordinary skill in the art that content generated and/or selected as described herein may be provided as part of any web page or on any web site by properly integrating embodiments of the invention with suitable devices, systems or platforms.

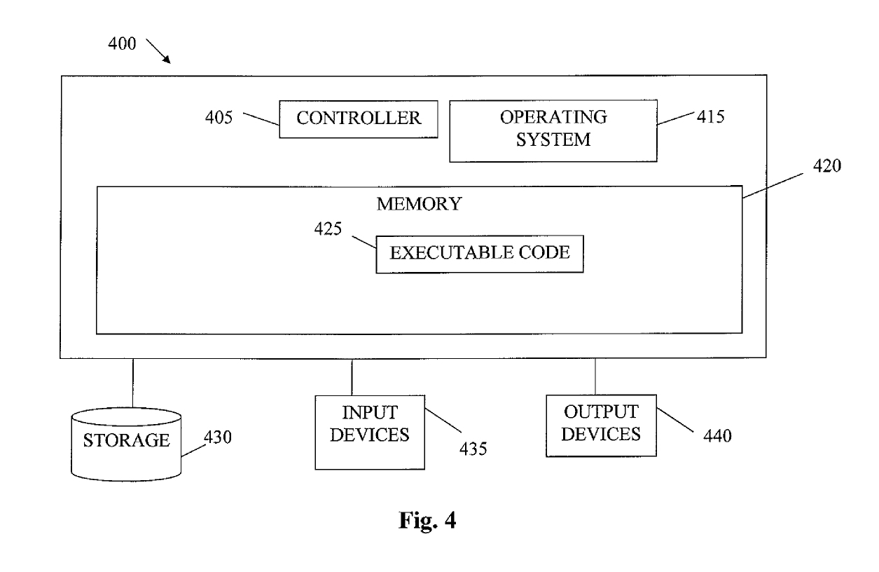

Reference is made to FIG. 4, showing high level block diagram of an exemplary computing device according to embodiments of the present invention. Computing device 400 may include a controller 405 that may be, for example, a central processing unit processor (CPU), a chip or any suitable computing or computational device, an operating system 415, a memory 420, a storage 430, an input device 435 and an output device 440.

Operating system may be or may include any code segment designed and/or configured to perform tasks involving coordination, scheduling, arbitration, supervising, controlling or otherwise managing operation of computing device 400, for example, scheduling execution of programs. Operating system 415 may be a commercial operating system. Memory 420 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 420 may be or may include a plurality of, possibly different memory units.

Executable code 425 may be any executable code, e.g., an application, a program, a process, task or script. Executable code 425 may be executed by controller 405 possibly under control of operating system 415. For example, executable code 425 may be a program or application that collects and analyzes information as described herein and further selects an advertisement as described herein. Although a single executable code 425 is shown, a number of such codes may be used in some embodiments of the invention. For example, a first executable code section may perform tasks as described with reference to collection unit 210, a second code segment may execute tasks as described with reference to update unit 220 and a third executable code may be related to selection or serving units 230 and 235 respectively. In other embodiments, units or modules such as those described with reference to FIG. 2 may be combined, e.g., into a single module or unit such as executable code 425. Storage 430 may be or may include, for example, a hard disk drive, a floppy disk drive, a Compact Disk (CD) drive, a CD-Recordable (CD-R) drive, a universal serial bus (USB) device or other suitable removable and/or fixed storage unit.

Input devices 435 may be or may include a mouse, a keyboard, a touch screen or pad or any suitable input device. It will be recognized that any suitable number of input devices may be operatively connected to computing device 400 as shown by block 435. Output devices 440 may include one or more displays, speakers and/or any other suitable output devices. It will be recognized that any suitable number of output devices may be operatively connected to computing device 400 as shown by block 440. Any applicable input/output (I/O) devices may be connected to computing device 400 as shown by blocks 435 and 440. For example, a network interface card (NIC), a printer or facsimile machine, a universal serial bus (USB) device or external hard drive may be included in input devices 435 and/or output devices 440. According to embodiments of the invention, computing devices operated by users A, B and C shown in FIG. 1 may comprise all or some of the components comprised in computing device 400 as shown and described herein.

Embodiments of the invention may include an article such as a machine, computer or processor non-transitory readable medium, or a non-transitory storage media accessible to a processor, e.g., a non volatile memory chip or other memory, a disk drive, or a USB flash memory, including or storing instructions, e.g., computer-executable instructions, which when executed by a processor or controller, carry out methods disclosed herein. For example, a storage medium such as memory 420, computer-executable instructions such as executable code 425 and a controller such as controller 405. Some embodiments may be provided in a computer program product that may include a machine-readable medium, stored thereon instructions, which may be used to program a computer, or other programmable devices, to perform methods as disclosed above.

It will be recognized that embodiments of the present invention may work together with ad servers. For example, the system of the present invention may identify one or more categories of suitable advertisements, and convey this information to a suitable ad server for selection of specific advertisements based thereon. For example, in some embodiments, or in some cases, a specific advertisement may be selected and served to one or more users, which may be retrieved by direct reference, e.g., by direct reference to a file server such as an ad server. In such embodiments or cases, advertisement selection may comprise selecting a category, criteria, or other parameters, rather than a particular advertisement. For example, an advertisement server may receive from an embodiment of the invention the parameter such as a category that may be suitable for a specific personality, and may select a particular advertisement to be served based at least in part on that parameter or category.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A method of providing content comprising:
obtaining text produced by a user of a social network;
analyzing said text to determine at least one parameter related to a personality of said user;
selecting at least one content object based on said at least one parameter for delivery to said user; and
delivering said selected at least one content object to said user.

2. The method of claim 1, comprising:
generating a plurality of content objects suitable for a respective plurality of personalities; and
selecting, from said plurality of content objects, said at least one content object based on a match between said parameter and said at least one content object.

3. The method of claim 1, comprising generating a content object based on said at least one parameter.

4. The method of claim 1, wherein said content comprises an advertisement.

5. The method of claim 1, wherein said at least one parameter is related to one of: an openness, a conscientiousness, an extraversion, an agreeableness and a neuroticism of said member.

6. The method of claim 1, comprising modifying a user profile according to said analysis and selecting content for delivery based on information in said user profile.

7. The method of claim 1, wherein said text is obtained from at least one of: an email, an on-line post, an on-line blog, an on-line forum, an on-line chat, an on-line status update, a search string provided to an on-line search engine, a social network application and a social network related web site.

8. The method of claim 1, wherein selecting said at least one content object based on said at least one parameter is based on a characteristic of said content object, wherein said characteristic is selected from the group consisting of: a color, a background, a visual effect, and an audio effect of said at least one content object.

9. The method of claim 1, wherein selecting said at least one content object is based on a content of a message related to said user.

10. An article comprising a non-transitory computer readable storage medium, having stored thereon instructions, that when executed on a computer, cause the computer to:
obtain text produced by a user of a social network;
analyze said text to determine at least one parameter related to a personality of said user;
select at least one content object based on said at least one parameter for delivery to said user; and
deliver said selected at least one content object to said user.

11. The article of claim 10, wherein the instructions when executed further result in:
generating a plurality of content objects suitable for a respective plurality of personalities; and
selecting, from said plurality of content objects, said at least one content object based on a match between said parameter and said at least one content object.

12. The article of claim 10, wherein the instructions when executed further result in generating a content object based on said at least one parameter.

13. The article of claim 10, wherein said content comprises an advertisement.

14. The article of claim 10, wherein said at least one parameter is related to one of: an openness, a conscientiousness, an extraversion, an agreeableness and a neuroticism of said member.

15. The article of claim 10, wherein the instructions when executed further result in modifying a user profile according to said analysis and selecting content for delivery based on information in said user profile.

16. The article of claim 10, wherein said text is obtained from at least one of: an email, an on-line post, an on-line blog, an on-line forum, an on-line chat, an on-line status update, a search string provided to an on-line search engine, a social network application and a social network related web site.

17. The article of claim 10, wherein selecting said at least one content object based on said at least one parameter is based on a characteristic of said content object, wherein said characteristic is selected from the group consisting of: a color, a background, a visual effect, and an audio effect of said at least one content object.

18. The article of claim 10, wherein selecting said at least one content object is based on a content of a message related to said user.
